(19) United States
(12) Patent Application Publication
(10) Pub. No.: US 2005/0052174 A1
(43) Pub. Date: Mar. 10, 2005

(54) Traceable patch cable and connector assembly and method for identifying patch cable ends

(76) Inventors: Deborah A. Angelo, Houston, TX (US); Ning Tsai, Houston, TX (US); Sonny Hom, Houston, TX (US)

Correspondence Address: WEI TE CHUNG;FOXCONN INTERNATIONAL, INC., 1650 MEMOREX DRIVE, SANTA CLARA, CA, 95050, US

(21) Appl. No.: 10/656,564

(22) Filed: Sep. 5, 2003

(51) Int. Cl. G01S 13/00

(52) U.S. Cl. 324/66

(57) ABSTRACT

A traceable patch cable (3) used to transmit signals from one receptacle (10) to another comprises a cable (32) and two connectors (31, 33) attached to opposite ends of the cable. The cable comprises at least one electrical wire (35) for transmitting signals and an optical fiber (36). The connectors each terminate an end of the electrical wire so that the electrical wire can be electrically connected to terminals in receptacles. Each connector forms an illuminating member (334) thereon with a passage (335) being defined in the illuminating member. Ends of the optical fiber are respectively terminated in the connectors under the illuminating members. Using a light beam shining through the passage at a first end of the cable, the light beam travels through the optical fiber to illuminates the illuminating member at a second end of the cable, thus making it easy to identify from among many cables.

### BACKGROUND OF THE INVENTION

1. Field of the Invention

The present invention relates to a system for identifying corresponding ends of patch cabling.

2. Description of Related Art

In commercial settings and office buildings, patch panels in closets are used by technicians to route telephone lines or networking cables to different destinations. Sometimes one of the services fails and it becomes necessary to trace the cable, finding an origin and destination, to insure that nothing has been unplugged and to check any equipment between the origin and destination to isolate the point of failure (i.e. equipment malfunction, cable damage, and/or disconnects). Often there are hundreds of cables which may even be tied together making it difficult to follow the physical cable from one point to the other. Difficulties are frequently encountered if there is no means of absolute identification, To prevent disrupting service of a working line while tracing a non-working line, a means to quickly identify the corresponding ends of a cable, with minimal unbundling and dismantling of restraints, is desired. Currently, labels and corresponding spreadsheets are often used, however, it is very difficult and time-consuming to identify the corresponding ends of cables from among hundreds of cables using their labels, and the cables can be easily damaged during the identification process.

Therefore, an improved traceable patch cable is desired which overcomes the disadvantages of the prior art.

### SUMMARY OF THE INVENTION

A main object of the present invention is to provide a traceable patch cable having ends which can be quickly and easily identified while preventing damage to the cables.

A traceable patch cable used to transmit signals from one receptacle to another comprises a cable and two connectors attached to opposite ends of the cable. The cable comprises at least one electrical wire for transmitting signals and an optical fiber. The connectors each terminate an end of the electrical wire so that the electrical wire can be electrically connected to terminals in receptacles. Each connector forms an illuminating member thereon with a passage being defined in the illuminating member. Ends of the optical fiber are respectively terminated in the connectors under the illuminating members. Using a light beam shining through the passage at a first end of the cable, the light beam travels through the optical fiber to illuminates the illuminating member at a second end of the cable, thus making it easy to identify from among many cables.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a perspective view of a connector assembly in accordance with a preferred embodiment of the present invention;

FIG. 2 is a cut-away view of a part of a patch cable of FIG. 1;

FIG. 3 is a perspective view of the patch cable of FIG. 1;

FIG. 4 is a cross-sectional section view taken along a line IV-IV of FIG. 3; and

FIG. 5 is a cross-sectional view of a part of the patch cable in accordance with another embodiment of the present invention and corresponding to FIG. 4.

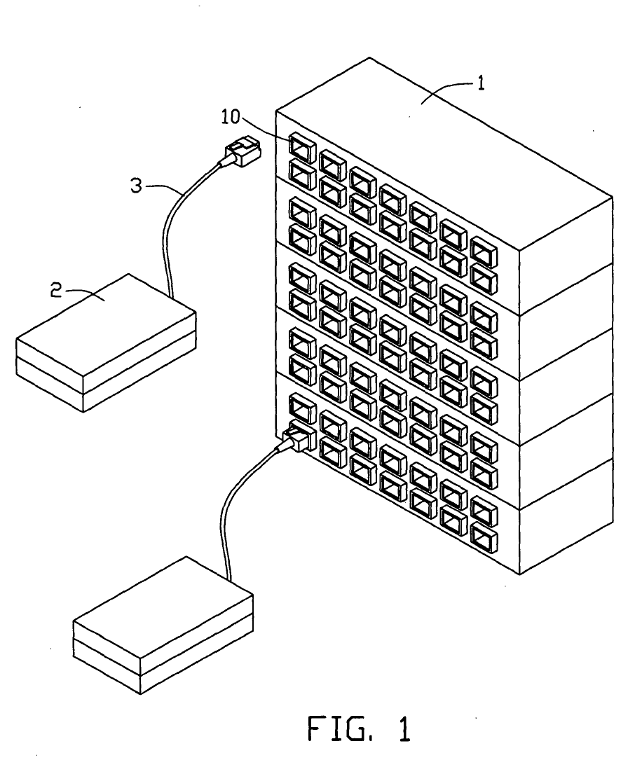

### DETAILED DESCRIPTION OF THE INVENTION

Referring now to the drawings in detail, FIG. I shows a connector assembly. The connector assembly comprises a patch panel 1, a plurality of terminals 2 (such as telephones or computers), and a plurality of traceable patch cables 3 each of which electrically connects the panel 1 and one terminal 2 for signal transmission therebetween. The panel 1 includes a plurality of receptacles 10, each of which is used to receive one end of a patch cable 3. The receptacles 10 are mounted in the panel 1 using suitable attaching means, such as screws or clasps. Each terminal 2 includes a receptacle (not shown) for accommodating the other end of the patch cable 3.

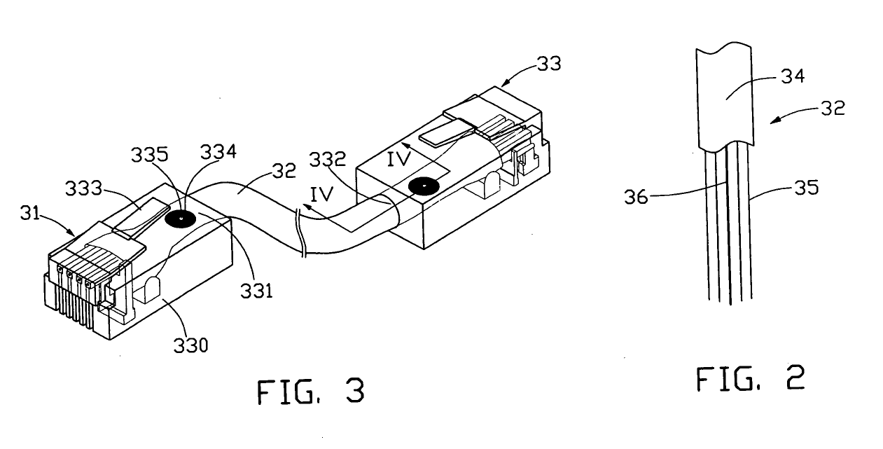

Referring to FIGS. 2 and 3 together, the patch cable 3 includes a cable 32 and two connectors 31, 33 disposed on opposite ends of the cable 3. The two connectors 31, 33 removably mate with a pair of receptacles which are respectively mounted in the panel 1 or a terminal 2. The cable 32 includes a jacket 34, a plurality of electrical wires 35 and a strand of optical fiber 36. The electrical wires 35 and the optical fiber 36 are encased in the jacket 34, which protects them from being damaged. The connectors 31, 33 may have the same structure, and each includes a transparent housing 330. The housing 330 defines a space 332 therein for accommodating one end of the cable 32 therein, wherein the electrical wires 35 are terminated in the housing 330 and are at least partly exposed to an outside of the housing 330 for electrically connecting with the receptacle 10 of the panel 1 or the receptacle of the terminal 2. An elastic tab 333 extends outwardly at an angle from the housing 330 for locking with the receptacle of the panel 1 or the terminal 2.

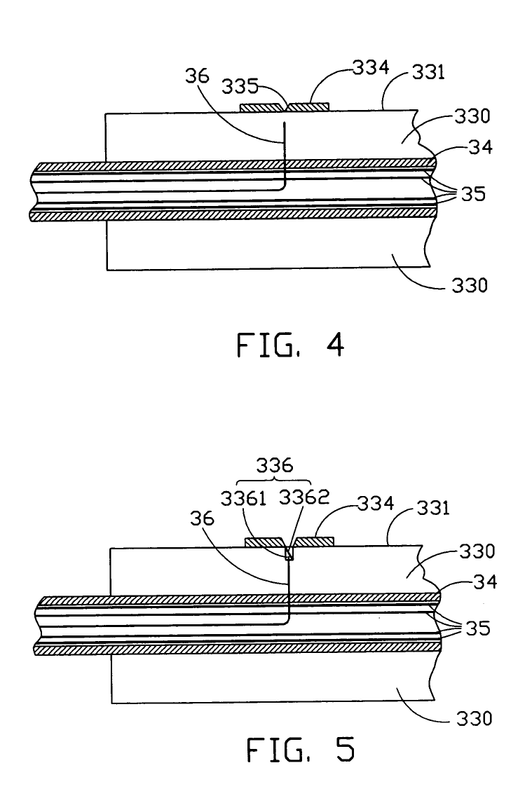

Also referring to FIG. 4, an illuminating member 334 is formed on an outer surface 331 of the housing 330 of each connector 31, 33. A passage 335 is defined in the center of the illuminating member 334. The illuminating member 334 is made from a luminescent material that luminesces when it receives light. In this embodiment, the illuminating member 334 is made from a material containing chrome by way of painting or sputtering the material onto the outer surface 331 of the housing 330 to a predetermined thickness and area. At each end of the cable 32, an end of the optical fiber 36 punctures the jacket 34 of the cable 32, extending upwardly into the housing 330 and being terminated therein under the illuminating member 334 and opposite to the passage 335. A predetermined distance is left between the illuminating member 334 and the corresponding end of the fiber 36.

When an external light beam (not shown) shines through the passage 335 of the connector 31 at a first end of the patch cable 32, the light travels through the optical fiber 36 from a first end to a second thereof. The light exiting from the second end of the optical fiber 36 is diffused and irradiates the illuminating member 334 on the connector 33 at a second end of the patch cable 32, thus the illuminating member 334 luminesces. Reversely, when the external light beam (not shown) shines through the passage 335 of the connector 33 at the second end of the patch cable 32, the light travels through the optical fiber 36 to irradiate the illuminating member 334 on the connector 31, and the illuminating member 334 luminesces at the first end of the patch cable 32 in the same manner described above. So a technician can quickly identify the ends of a cable at an origin and a destination, helping to isolate the point of failure by using an external light beam shining through one end of the patch cable 32 and finding the corresponding second end being illuminated without disrupting services of other cables. The illuminating member 334 can be designed as a circle around the passage 335 or another shape for easier identification.

Referring to FIG. 5, in a second embodiment, between each of the illuminating members 334 and the corresponding end of the optical 36 is disposed a collimator 336, which includes a ferrule 3361 for fixing the corresponding end of the optical fiber 36, and a lens 3362 for collimating light. Other elements is corresponding to the first embodiment. When an external light beam (not shown) shines through the passage 335 in the center of the illuminating member 334 at the connector 31 at a first end of the cable 32, the light passes through a first collimator 336 at the connector 31, is focused at a first end of the optical fiber 36, and travels through the optical fiber 36 to a second end thereof. The light then exits from a second collimator 336 at the connector 33 at a second end of the cable 32, and becomes a parallel light beam to irradiate the illuminating member 334 at the connector 33, thus the illuminating member 334 luminesces at the second end of the patch cable 32, so that the technician can identify it from among many cable ends. This allows the technician to quickly check any equipment between the origin and destination to isolate the point of failure, just by using an external light beam shining through one end of the patch cable 32 and finding the other illuminated end. This prevents disruption in services.

It is understood that only one of the connectors 31, 33 forms the illuminating member 334 on the housing 330 with or without a passage 335 formed therein, and the other connector forms a passage 335 therein which communicates with a corresponding end of the optical fiber 36 terminated in the connector. Using a light beam shining the passage 335 at one end of the cable 32, the light travels through the optical fiber 36 and irradiates the illuminating member 334, thus the illuminating member 334 luminesces at the other end of the cable 32 in the same manner as described above for identification.

It is understood that the invention may be embodied in other forms without departing from the spirit thereof. Thus, the present examples and embodiments are to be considered in all respects as illustrative and not restrictive, and the invention is not to be limited to the details given herein.

1. A traceable patch cable used to transmit signals from a receptacle to another receptacle comprising:
a cable; and
two connectors disposed on opposite ends of said cable;
wherein said cable comprises at least one electrical wire for transmitting signals and an optical fiber for transmitting light, said connectors terminate said at least electrical wire therein so that the at least one electrical wire can be electrically connected to at least a terminal in a corresponding said receptacles, at least a first of the two connectors defines a passage and terminates a first end of the optical fiber opposite to the passage, a second of the two connectors forms an illuminating member thereon and terminates a second end of the optical fiber therein with a predetermined distance left between the illuminating member and the second end of the optical fiber, when a light beam shines through the passage of the first connector at a first end of the patch cable, the light travels through the optical fiber from a first end to a second end thereof, the light exiting from the second end of the optical fiber irradiates the illuminating member of the second connector at a second end of the patch cable, and thus the illuminating member luminesces for identification.

2. The traceable patch cable as claimed in claim 1, wherein each of the two connectors comprises an illuminating member, and said passage is defined in each illuminating member.

3. The traceable patch cable as claimed in claim 1, wherein the illuminating member is made from a luminescent material that can luminesce when it receives light.

4. The traceable patch cable as claimed in claim 3, wherein the illuminating member is formed by painting or sputtering.

5. The traceable patch cable as claimed in claim 4, wherein the illuminating member is made from a material containing chrome.

6. The traceable patch cable as claimed in claim 1, wherein an optical collimator is disposed between the illuminating member and the corresponding end of the optical fiber.

7. The traceable patch cable as claimed in claim 6, wherein the illuminating member comprises a ferrule for fixing the optical fiber and a lens for or collimating light.

8. The traceable patch cable as claimed in claim 1, wherein said connector comprises a transparent housing, and the illuminating member is formed on an outer surface of the transparent housing.

9. The traceable patch cable as claimed in claim 8, wherein the ends of the optical fiber are fixed in the housing respectively opposite to the illuminating member and the passage.

10. A connector assembly comprising:
a patch panel;
a plurality of terminals; and
a plurality of patch cables, each patch cable electrically connecting the patch panel and one terminal for signal transmission therebetween, each patch cable comprising a cable and two connectors disposed on opposite ends of the cable, the two connector respectively mating with the patch panel and one terminal; wherein
the cable comprises at least one electrical wire to transmit signals between the patch panel and the terminal, and further comprise an optical fiber for transmitting light therethrough, wherein at least one of the two connectors defines a passage therein, the other of the two connectors forms an illuminating member, using a light beam shining through the passage at a first end of the cable, the light travels through the optical fiber and irradiates the illuminating member, the illuminating member then luminesces at a second end of the cable for identification.

11. The connector assembly as claimed in claim 10, wherein each of the two connectors comprises an illuminating member, and said passage is defined in each illuminating member.

12. The connector assembly as claimed in claim 10, wherein the illuminating member is made from a luminescent material that can luminesce when it receives light.

13. The connector assembly as claimed in claim 10, wherein an optical collimator is disposed between the illuminating member or the passage and the corresponding end of the optical fiber.

14. The connector assembly as claimed in claim 10, wherein said connector comprises a transparent housing, and the illuminating member is formed on an outer surface of the transparent housing.

15. A method for identifying corresponding ends of a patch cable used to transmit signals between a pair of receptacles, the patch cable comprising a cable and two connectors disposed on opposite ends of the cable, the cable having at least one electrical wire for signal transmission and an optical fiber for transmitting light, the connectors respectively removably mate with the receptacles, the method comprising the steps of:
forming a passage at least in a first of the two connectors and an illuminating member at least on a second of the two connectors;
providing an external light beam shining through the passage of the first connector at a first end of the patch cable, then the light traveling through the optical fiber to irradiate the illuminating member of the second connector at a second end of the patch cable;
identifying the illuminated ends at the second end of the patch cable as the corresponding end.

16. The method as claimed in claim 15, wherein each of the two connectors comprises an illuminating member, and each illuminating member defines said passage therein.

17. A traceable cable assembly comprising:
a cable including at least one wire for transmission of signal and at least one transmitting device; and
a pair of connectors attached to two opposite ends of the cable, respectively, each of said connectors including at least one contact electrically connected to the at least one wire, for implementing the transmission of the signal, at least one of said connectors further including an actuating device which intentionally and independently initiates, either actively or passively, an identification symbol, wherein said identification symbol moves along said transmitting device and is able to be visually identified on the other one of said connectors.

18. The traceable cable assembly as claimed in claim 17, wherein said both said pair of connectors are equipped with said actuating devices, and an identification process between said pair of connectors is adapted to be practiced in dual directions.

19. The traceable cable assembly as claimed in claim 17, wherein said identification symbol is a light beam rather than an electrical signal.

20. The traceable cable assembly as claimed in claim 17, wherein said transmitting device is either an optic fiber or a light pipe
